(19) United States
(12) Patent Application Publication
(10) Pub. No.: US 2025/0256658 A1
(43) Pub. Date: Aug. 14, 2025

(54) BIKE MOUNT MECHANISMS

(71) Applicant: Rivian IP Holdings, LLC, Irvine, CA (US)

(72) Inventors: Austin Lee Frederickson, Carlsbad, CA (US); Nathan Eino Heronen, San Juan Capistrano, CA (US); Daniel Geoffrey Walker, Dana Point, CA (US); Mohamad Jeffery Hammoud, Bloomfield Hills, MI (US)

(73) Assignee: Rivian IP Holdings, LLC, Irvine, CA (US)

(21) Appl. No.: 19/052,968

(22) Filed: Feb. 13, 2025

Related U.S. Application Data
(60) Provisional application No. 63/553,421, filed on Feb. 14, 2024.

(51) Int. Cl. B60R 9/10; B60R 9/06; B60R 11/00

(52) U.S. Cl. CPC B60R 9/10; B60R 9/06; B60R 2011/0082; B60R 2011/0084; B60R 2011/0085

(57) ABSTRACT

An apparatus can include an adjustment assembly. The adjustment assembly can move an arm of the apparatus. The adjustment assembly can include a first member and a second member. The first member can disengage from the second member. The second member can rotate relative to the first member to move the arm with the first member disengaged from the second member.

### CROSS-REFERENCE TO RELATED PATENT APPLICATIONS

This application claims the benefit of and priority to U.S. Provisional Patent Application No. 63/553,421, filed on Feb. 14, 2024, the entirety of which is incorporated by reference herein.

### INTRODUCTION

Vehicles can carry or transport equipment.

### SUMMARY

This disclosure is generally related to one or more components of a vehicle. The components can include at least one apparatus. The apparatus can include at least one of adjustment assembly. The adjustment assembly can include at least one member. For example, the adjustment assembly can include a first member and a second member. The members can be engaged with another. For example, a first portion of the first member can be in contact with a first portion of the second member. The members can disengage from one another. For example, the first member can disengage from the second member. The second member can move relative to the first member with the first member disengaged from the second member.

At least one aspect is directed to an apparatus. The apparatus can include an adjustment assembly. The adjustment assembly can move an arm of the apparatus. The adjustment assembly can include a first member and a second member. The first member can disengage from the second member. The second member can rotate relative to the first member to move the arm with the first member disengaged from the second member.

At least one aspect is directed to a vehicle. The vehicle can include an apparatus. The apparatus can include an adjustment assembly. The adjustment assembly can move an arm of the apparatus. The adjustment assembly can include a first member and a second member. The first member can disengage from the second member. The second member can rotate relative to the first member to move the arm with the first member disengaged from the second member.

At least one aspect is directed to a method. The method can include disposing, within a body of an apparatus, an adjustment assembly. The adjustment assembly can include a first member and a second member. The adjustment assembly can move an arm of the apparatus. The method can also include disengaging, via an interface assembly of the apparatus, the first member from the second member. The method can also include rotating, responsive to disengaging the first member from the second member, the second member to move the arm of the apparatus.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle, in accordance with an implementation.

FIG. 2 depicts a perspective view of an apparatus, in accordance with an implementation.

FIG. 3 depicts a perspective view of a vehicle including the apparatus illustrated in FIG. 2, in accordance with an implementation.

FIG. 4 is a perspective view of an apparatus, in accordance with an implementation.

FIG. 5 is a cross-sectional view of the apparatus illustrated in FIG. 4, in accordance with an implementation.

FIG. 6 is a perspective view of the apparatus illustrated in FIG. 4, in accordance with an implementation.

FIG. 7 is a cross-sectional view of the apparatus illustrated in FIG. 4, in accordance with an implementation.

FIG. 8 is a perspective view of the apparatus illustrated in FIG. 4, in accordance with an implementation.

FIG. 9 is a perspective view of a mounting assembly included in the apparatus illustrated in FIG. 4, in accordance with an implementation.

FIG. 10 is a perspective view of the mounting assembly illustrated in FIG. 9, in accordance with an implementation.

FIG. 11 is perspective view of an attachment assembly, in accordance with an implementation.

FIG. 12 is a cross sectional view of the apparatus illustrated in FIG. 4, in accordance with an implementation.

FIG. 13 is a perspective view of an arm included in the apparatus illustrated in FIG. 4, in accordance with an implementation.

FIG. 14 is a cross-sectional view of a coupling assembly included in the apparatus illustrated in FIG. 4, in accordance with an implementation.

FIG. 15 is cross-sectional view of the coupling assembly illustrated in FIG. 14, in accordance with an implementation.

FIG. 16 is a perspective view of the coupling assembly illustrated in FIG. 14, in accordance with an implementation.

FIG. 17 is a perspective view of the coupling assembly illustrated in FIG. 14, in accordance with an implementation.

FIG. 18 is a perspective view of a linkage included in the coupling assembly illustrated in FIG. 14, in accordance with an implementation.

FIG. 19 is a perspective view of a linkage included in the coupling assembly illustrated in FIG. 14, in accordance with an implementation.

FIG. 20 is a perspective view of a crossbar included in the vehicle illustrated in FIG. 1, in accordance with an implementation.

FIG. 21 depicts a flow diagram of a process of manufacturing an apparatus, in accordance with an implementation.

FIG. 22 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of an apparatus including one or more components. The various concepts introduced above and discussed in greater detail below may be implemented in any of numerous ways.

The present disclosure is directed to systems and methods of one or more components for a vehicle. The components can include an apparatus. The apparatus can include an adjustment assembly. The adjustment assembly can include at least one member. The members can engage with one another. For example, a first member can engage with a second member. The engagement of the members can lock or hold one or more components of the apparatus. For example, the engagement of the member can hold an arm of the apparatus. The apparatus can include a body. For example, the apparatus can include a frame, a structure, or a housing. The adjustment assembly can be disposed within the body. For example, the adjustment assembly can be located within the body.

The apparatus can be provided with the vehicle. For example, the apparatus can be included with the vehicle. The apparatus can also be provided separate from the vehicle. For example, the apparatus can be provided as one or more components separate from the vehicle. The apparatus can also include a surface or platform to hold an object. For example, the apparatus can support bicycle. As another example, the apparatus can support a wheel of a vehicle.

The adjustment assembly can control motion or movement of one or more components of the apparatus. For example, the adjustment assembly can move an arm having a hoop that receives a tire of a bicycle. As another example, the adjustment assembly can lock the arm in one or more locations or position. The adjustment assembly can control movement of the arm without the use of tools or fasteners. For example, the adjustment assembly can release the arm without having to first loosen of remove a fastener. As another example, the adjustment assembly can pivot the arm from a first position to a second position and then lock the arm in the second position without the use of tool.

The apparatus or one or more components thereon can be included with a bike rack system or a bike rack mechanism. For example, the apparatus can be included with a bike rack that couples with a vehicle. The apparatus can be removably coupled with the bike rack. For example, the apparatus can be decoupled from the bike rack and then subsequently recoupled.

Other bike racks or mounting mechanisms can include adjustable components. However, the adjustable components require tools and equipment when adjusting. For example, a tool to loosen a fastener must be used in order to move a component of these bike racks from a first position to a second position. This process can prove difficult and time consuming as the fasteners can be difficult to remove or loosen, which ultimately impacts the usability of these bike racks. Additionally, without the tools or equipment, these components cannot be adjusted or moved.

The disclosed solutions have a technical advantage of providing the adjustment assembly that includes components that can be adjusted or moved without the use of tools or equipment. The adjustment assembly can include members that engaged with another to hold or lock given components of the apparatus in place. The members can engage with one another without the use of tools or equipment.

Some of the present technical solutions also include the arrangement or placement of the components of the apparatus. For example, the adjustment assembly can be housed within a body of the apparatus such that the adjustment assembly is isolated or separately from an external environment. The location or placement of the adjustment assembly can protect or shield the components of the adjustment assembly from things such as debris, water, dirt, or dust.

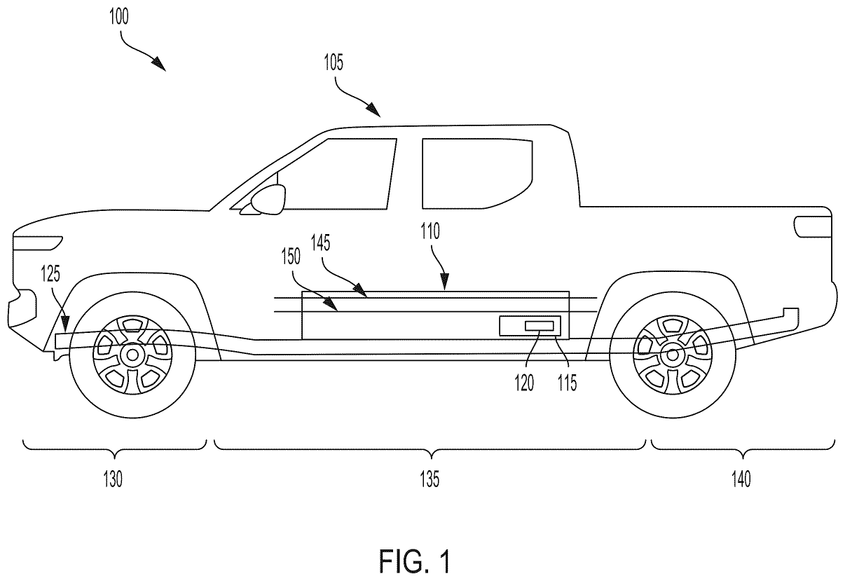

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

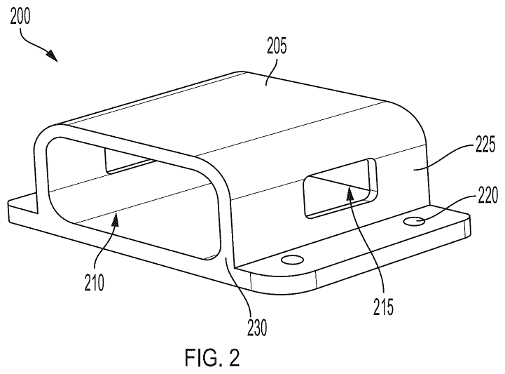

FIG. 2 depicts a perspective view of an apparatus 200. The apparatus 200 can include the apparatus described herein. For example, the apparatus 200 can provide at least one of the technical solutions described herein. The apparatus 200 can be coupled with a vehicle. For example, the apparatus 200 can be coupled with the vehicle 105. The apparatus 200 can be coupled with the vehicle 105 by at least one of attaching, mounting, securing, or connecting the apparatus 200 with the vehicle 105. For example, the apparatus 200 can be coupled with the chassis 125 of the vehicle 105. As another example, the apparatus 200 can couple with a crossbar of the vehicle 105.

The apparatus 200 can include at least one structural support attachment 205. The structural support attachment 205 can include the structural support attachment described herein. The structural support attachment 205 can interface with, engage with, or otherwise interact with at least one of the various components described herein. For example, the structural support attachment 205 can engage with the attachment mechanism described herein. The structural support attachment 205 can couple with a vehicle. For example, the structural support attachment 205 can couple with the vehicle 105.

The structural support attachment 205 can include a bumper port 205. The bumper port 205 can be coupled with the vehicle 105. For example, the bumper port 205 can be attached to the vehicle 105 via one or more fasteners. The bumper port 205 can be disposed within a portion of the vehicle 105. For example, the bumper port 205 can be placed or located within a rear bumper of the vehicle 105. Stated otherwise, the bumper port 205 can be disposed within a portion of the vehicle 105 that is located proximate to the rear of the vehicle 105 (e.g., a rear bumper or a rear portion). As another example, the bumper port 205 can be located in one or more positions of the vehicle 105, such as the roof of the vehicle 105, the tailgate of the vehicle 105, the liftgate of the vehicle 105, a door of the vehicle 105, or a top portion of the vehicle 105.

The bumper port 205 can include at least one opening 210, at least one aperture 215, at least one slot 220, and at least one housing 230. The opening 210 can define or otherwise establish a body, a housing, or an assembly of the bumper port 205. For example, the opening 210 can define the housing 230. The opening 210 can receive the attachment mechanism described herein. For example, the protruded portion of the attachment mechanism can be inserted into the opening 210. The opening 210 can provide access to the housing 230. For example, the opening 210 can provide a void or a cavity for the body of the attachment mechanism to be inserted into. The opening 210 can position at least a portion of the body within a portion of the vehicle. For example, the opening 210 can position the body of the attachment mechanism within the bumper of the vehicle 105.

The bumper port 205 can engage with the attachment mechanism. For example, the bumper port 205 can engage with the body of the attachment mechanism responsive to a spring-load block wedge applying a load to the bumper port 205. Stated otherwise, the body of the attachment mechanism can connect or interface with the bumper port 205. The housing 230 can include at least one face 225. For example, the housing 230 can include a first face 225 and a second face 225. The faces 225 can include the apertures 215. For example, the first face 225 can include a first aperture 215 and the second face 225 can include a second aperture 215. The apertures 215 can be located or disposed within the faces 225. For example, the apertures 215 can define a gap or a hole within the faces 225.

The apertures 215 can receive at least one of the various components described herein. For example, the apertures 215 can receive the pawls (e.g., a protrusion) described herein. The apertures 215 can provide an opening, a hole, or a gap to allow the pawls to escape or otherwise exist the housing 230 of the bumper port 205. The slots 220 can receive at least one fastener. For example, the slots 220 can receive a bolt or a screw. The slots 220 can couple the bumper port 205 with the vehicle 105 responsive to the slots receiving at least one fastener.

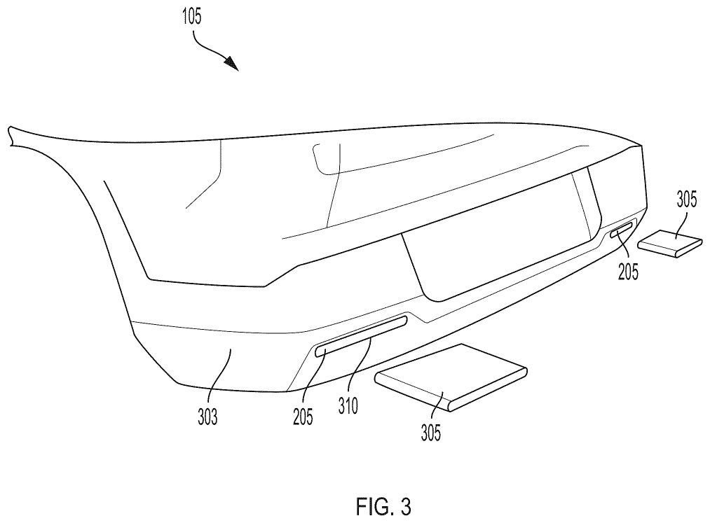

FIG. 3 depicts a perspective view of the vehicle 105. The vehicle 105 can include at least one portion 303. The portions 303 can include one or more various components, locations, or spots of the vehicle 105. The portions 303 can be located proximate to the rear of the vehicle 105. For example, the portions 303 can be located proximate to a rear bumper of the vehicle 105. As another example, the portions 303 can include the chassis 125. As even another example, the portions 303 can include various locations or portions of the vehicle 105. The portions 303 can include at least one opening 310. The openings 310 can include a void or a gap for which the bumper port 205 can be accessible. For example, the openings 310 can provide access to the opening 210.

The apparatus 200 can include a first bumper port 205 and a second bumper port 205. The first bumper port 205 can be disposed within a first opening 310. The second bumper port 205 can be disposed within a second opening 310. FIG. 3 depicts an example of a first bumper port 205 disposed within a first opening 310 and an example of a second bumper port 205 disposed within a second opening 310. The first bumper port 205 can support a first portion of a tray. For example, the first bumper port 205 can support a first part of a bike rake (e.g., a tray). As another example, the second bumper port 205 can support a second part of the bike rake. The first bumper port 205 and the second bumper port 205 both supporting a part of the tray can refer to a uniform weight distribution.

The apparatus 200 can include at least one plug 305. The plug 305 can be inserted into the opening 310. The plug 305 can enclose or cover the bumper port 205. For example, the plug 305 can isolate the bumper port 205 from an external environment (e.g., rain, dirt, dust, mud, snow, etc.). The plug 305 can also prevent debris from entering the housing 230. FIG. 3 depicts an example of the plug 305 external to the opening 310 (e.g., the plug 305 is not covering the bumper port 205).

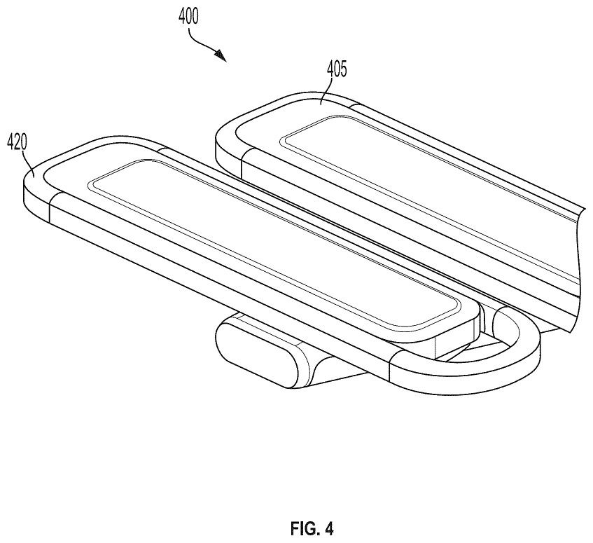

FIG. 4 is a perspective view of an apparatus 400. The apparatus 400 can include the apparatus described herein. The apparatus 400 can include at least one body 405. The body 405 can include a frame or structure. The body 405 can define or establish a shape of the apparatus 400. The apparatus 400 can couple with the vehicle 105. For example, the apparatus 400 or a portion thereof can couple with the bumper port 205. As another example, the apparatus 400 can be inserted into the portions 303. The apparatus 400 can refer to or include a bike rack or one or more components of the bike rack. For example, the apparatus 400 can hold or support a tire of a bike. The apparatus 400 can include at least one arm 420. The arm 420 can refer to or include the arm described herein. For example, the arm 420 can hold or receive a bike tire.

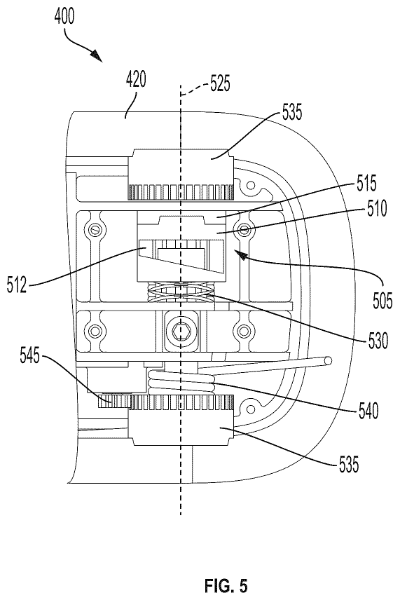

FIG. 5 is a cross-sectional view of the apparatus 400. The cross-sectional view, as shown in FIG. 5, can include a view of the apparatus 400 from a bottom view, an under view, or an upside-down view. The cross-sectional view can illustrate an internal view of the body 405. The apparatus 400 can include at least one adjustment assembly 505. The adjustment assembly 505 can include the adjustment assembly described herein. The adjustment assembly 505 can refer to or include a dog clutch. The adjustment assembly 505 can move one or more components of the apparatus 400. For example, the adjustment assembly 505 can move the arm 420. The adjustment assembly 505 can move the arm 420 from a stowed position (e.g., a position similar to the position of the arm 420 shown in FIG. 4) to a deployed position (e.g., a position to receive a tire of a bike).

The adjustment assembly 505 can include at least one member. For example, the adjustment assembly can include at least one member 510 and at least one member 515. The member 510 can include a first member. The member 510 can also include a sliding collar. The member 510 can include a gap 512. The gap 512 can receive an inclined plane to move the member 510. The member 515 can include a second member. The member 515 can also include a roller clutch. The members (e.g., the member 510 and the member 515) can refer to or include the members described herein. For example, the member 510 can engage with the member 515. FIG. 5 depicts an example of the member 510 engaged with the member 515. The apparatus 400 can include at least one spring 530, at least one clutch assembly 535, at least one spring assembly 540, and at least one damper 545.

The member 510 can disengage from the member 515. For example, the member 510 can compress or move the spring 530 to disengage from the member 515. The member 510 can disengage from the member 515 by moving along axis 525. For example, the member 510 can disengage from the member 515 by moving away from the member 515. The member 515 can move relative to the member 510. For example, the member 515 can rotate about the axis 525. The disengagement of the member 510 can cause the member 515 to rotate. For example, the spring assembly 540 can apply a torsional force on the member 515. To continue this example, the disengagement of the member 510 from the member 515 can cause the member 515 to rotate via the torsional force applied by the spring assembly 540 on the member 515. The member 515 can rotate relative to the member 510 to move the arm 420. For example, the member 515 can rotate to move the arm 420 from a stowed position to a deployed positioned.

The spring assembly 540 can rotate the arm 420. For example, the member 515 can be coupled with the arm 420. To continue this example, the spring assembly 540 can rotate the member 515 about the axis 525, which in turn can rotate the arm 420. The spring assembly 540 can rotate the arm 420 with the member 510 disengaged from the member 515. The member 515 can be coupled with the clutch assembly 535. For example, the member 515 can be secured, attached, affixed, or otherwise mounted to the clutch assembly 535. The member 515 can rotate or move in one or more directions, relative to clutch assembly 535. For example, the member 515 can move via at least one of a roller ramp clutch, a one way bearing, a sprag bearing, or a ratchet. The damper 545 can control movement of the clutch assembly 535. For example, the damper 545 can resist or slow movement of the clutch assembly 535.

The clutch assembly 535 can be coupled with the arm 420. For example, the clutch assembly 535 can be secured to the arm 420. The clutch assembly 535 can couple the member 515 with the arm 420. For example, the clutch assembly 535 can indirectly couple the member 515 with the arm 420. To continue this example, the arm 420 can move, via the clutch assembly 535, responsive to rotation of the member 515. The clutch assembly 535 can rotate with the member 515 disengaged from the member 510. For example, rotation of the member 515 can cause the clutch assembly 535 to also rotate.

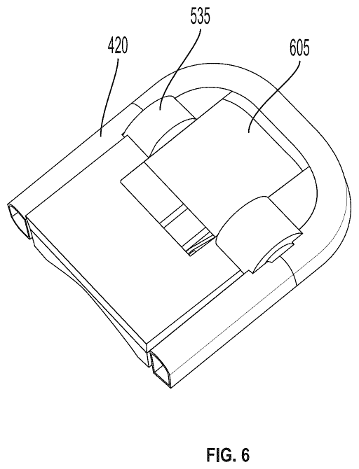

FIG. 6 is a perspective view of the apparatus 400. The view of the apparatus 400, as shown in FIG. 6, can refer to or include a bottom view, an under view, or an upside-down view. The adjustment assembly 505 can be disposed within the body 405. For example, the adjustment assembly 505 can be located or housed within the body 405. The body 405 can include an interface assembly 605. The interface assembly 605 can include at least one of a slide, a glide, a button, or a movable element. The interface assembly 605 can interface with the member 510. For example, the interface assembly 605 can contact or touch the member 510. The interface assembly 605 can cause the member 510 to disengage from the member 515. For example, the interface assembly 605 can cause the member 510 to move along the axis 525. As another example, the interface assembly 605 can cause the member 510 to compress the spring 530.

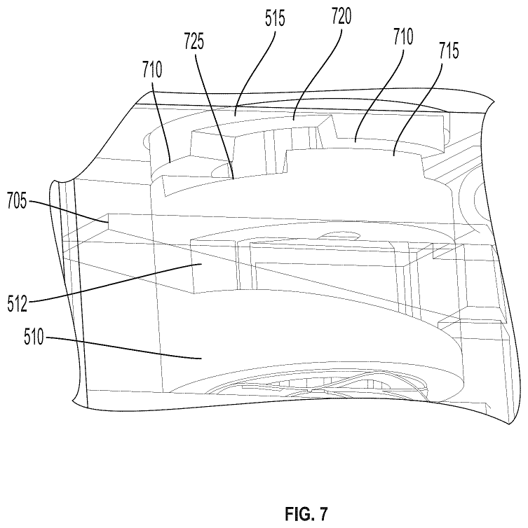

FIG. 7 is a cross-sectional view of the apparatus 400. The interface assembly 605 can include a plane 705 or wedge 705. The plane 705 can include an inclined plane. The plane 705 can insert within a portion of the member 510. For example, the member 510 can include an opening, a void, or a gap (e.g., the gap 512). To continue this example, the plane 705 can insert into the member 510 via the gap 512. The plane 705 can move responsive to engagement of the interface assembly 605. For example, the plane 705 can move responsive to sliding the interface assembly 605. The plane 705 can cause the member 510 to disengage from the member 515. For example, insertion of the plane 705 into the gap 512 can cause the member 510 to compress the spring 530.

The member 510 can include at least one protrusion 715 and at least one slot 725. The protrusions 715 can refer to or include at least one of teeth, extensions, or elongated members. The protrusions 715 can engage with the member 515. The member 515 can include at least one protrusion 710 and at least one slot 720. The slots 720 can receive the protrusions 715. For example, the protrusions 715 can be inserted into the slots 720. The insertion of protrusions 715, into the slots 720, can engage the member 510 with the member 515.

The protrusions 715 can engage with the slots 720. For example, the protrusion 715 can be inserted into a first slot 720. As another example, the protrusion 715 can be inserted into a second slot 720. The protrusion 715 can be inserted into a first slot 720 with the arm 420 in the deployed position. The protrusion 715 can engaged with the first slot 720 with the member 510 engaged with the member 515. For example, engagement of the member 510 with the member 515 can result from engagement of the protrusion 715 with the first slot 720. The engagement of the protrusion 715 with the first slot 720 can lock or maintain a position of the member 515. For example, the engagement can lock the member 515 in a first position.

Disengagement of the protrusions 715 from the first slot 720 can cause the member 510 to disengage from the member 515. For example, the plane 705 inserting into the gap 512 can cause the protrusions 715 to disengage from the first slot 720. The disengagement of the first member 510 from the second member 515 can cause the protrusion 715 to no longer align with the first slot 720. For example, the first slot 720 can rotate responsive to disengagement of the member 510 from the member 515. The rotation of the first slot 720 can cause a second slot 720 to align with the protrusion 715. For example, the member 515 can rotate about the axis 525 and the second slot 720 can align with the protrusion 715 responsive to the rotation of the member 515.

The slots 720 can be separated by one or more angles. For example, a first slot 720 and a second slot 720 can be separated by 180 degrees (e.g., an angle). As another example, a first slot 720, a second slot 720, and third slot 720 can be separated by 120 degrees. The separation (e.g., a degree difference between the slots 720) can define a rotation amount. For example, a first slot 720 that is separated from a second slot by 120 degrees can define a rotation amount that the arm 420 can rotate (e.g., an angular rotation). Stated otherwise, disengagement of the member 515 from the member 510 can cause the member 515 to rotate by a given amount (e.g., the degree difference between the slots 720). For example, the first slot 720 and the second slot 720 can be separated by 120 degrees. To continue this example, the arm 420 can rotate, responsive to disengagement of the member 510 from the member 515, by 120 degrees prior to an engagement between the protrusion 715 and a second slot 720 of the member 510.

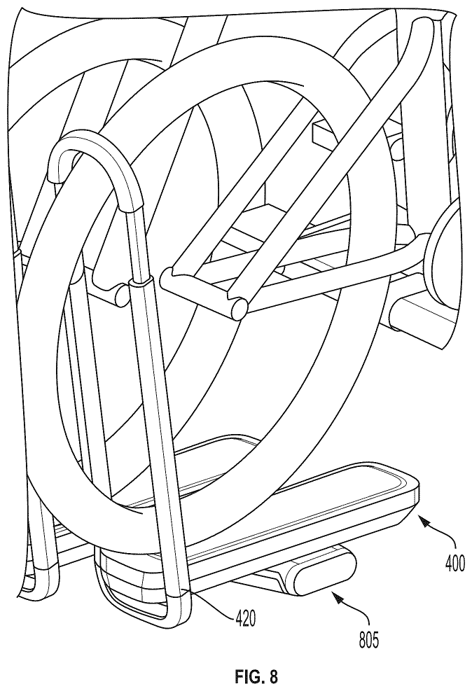

FIG. 8 is a perspective view of the apparatus 400. The apparatus 400 can be coupled with an attachment assembly 805. For example, the apparatus 400 can be secured to the attachment assembly 805. The attachment assembly 805 can be coupled with the vehicle 105. For example, the attachment assembly 805 can couple with the bumper port 205. FIG. 8 depicts an example of the arms 420 in a deployed position (e.g., disengagement of the member 510 from the member 515 cause the arms 420 to rotate). The apparatus 400 is shown supporting a tire of a bike and the arm 420 is shown having received the tire of the bike.

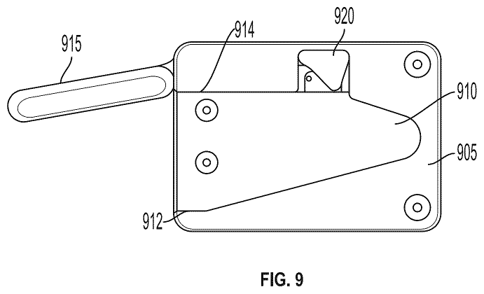

FIG. 9 is a perspective view of a mounting assembly 905. The apparatus 400 can include the mounting assembly 905. For example, the mounting assembly 905 can be located on a bottom side of the apparatus 400. The mounting assembly 905 can couple the apparatus 400 with the attachment assembly 805. For example, the mounting assembly 905 can secure the apparatus 400 to the attachment assembly 805. The mounting assembly 905 can include at least one recess 910, at least one lever 915, and at least one engagement element 920. The lever 915 can be coupled with the engagement element 920. For example, the lever 915 can be secured to the engagement element 920. The lever 915 can control or move the engagement element 920. For example, the lever 915 can move the engagement element 920 from a first position to a second position. The engagement element 920 can include a retracted position (e.g., a position or placement similar to that shown in FIG. 9) and a deployed position. The recess 910 can include at least one portion 912 and at least one portion 914. The portions (e.g., the portion 912 and the portion 914) can guide one or more objects. For example, the portion 912 and the portion 914 can guide a protrusion of the attachment assembly 805.

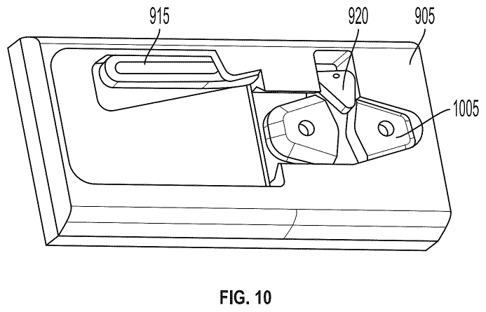

FIG. 10 is a perspective view of the mounting assembly 905. The recess 910 can receive a protrusion 1005. The attachment assembly 805 can include the protrusion 1005. The recess 910 can receive the protrusion 1005 to couple the apparatus 400 with the vehicle 105. For example, the apparatus 400 can couple with the attachment assembly 805 responsive to the recess 910 receiving the protrusion 1005. The lever 915 can move the engagement element 920 to engage the engagement element 920 with the protrusion 1005. For example, the lever 915 can move the engagement element 920, from the position shown in FIG. 9 to the position shown in FIG. 10, to engage the engagement element 920 with the protrusion 1005. The engagement of the engagement element 920 with the protrusion 1005, can couple the apparatus 400 with the attachment assembly 805.

The engagement element 920 can move the protrusion 1005. For example, the engagement element 920 can move the protrusion 1005 from a first position to a second position. As another example, the engagement element 920 can move the protrusion 1005 further into the recess 910. The portion 912 and the portion 914 can guide the protrusion 1005. For example, the portion 912 and the portion 914 can guide the protrusion 1005 to the position of the protrusion 1005 as shown in FIG. 10.

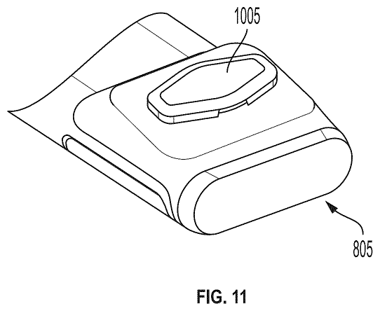

FIG. 11 is perspective view of the attachment assembly 805. The attachment assembly 805 can include the protrusion 1005. The protrusion 1005 can be coupled with a top portion of the attachment assembly 805. The protrusion 1005 can be removed from the apparatus 400. For example, the protrusion 1005 can be removed from the recess 910 of the apparatus 400. The protrusion 1005 can be removed from the apparatus 400 responsive to the engagement element 920 disengaging with the protrusion 1005.

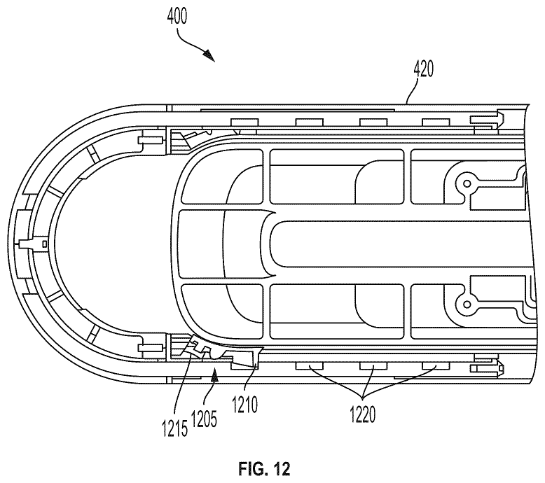

FIG. 12 is a cross-sectional view of the apparatus 400. The apparatus 400 can include a button assembly 1205. The button assembly 1205 can include at least one pin 1210 and at least one spring 1215. The pin 1210 or element 1210 can insert into at least one groove 1220 or notch 1220. The arm 420 can include the grooves 1220. The pin 1210 can lock or maintain a position or a placement of one or more portions of the arm 420. For example, the pin 1210 can restrict movement in a first direction or allow movement in a second direction.

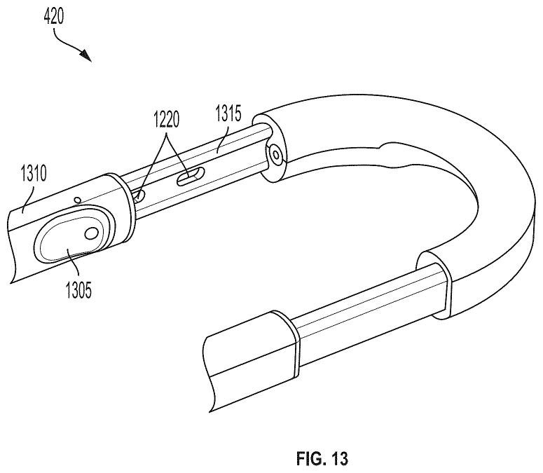

FIG. 13 is a perspective view of the arm 420. The arm 420 can include at least one segment 1310 and at least one segment 1315. The segment 1310 can include a first segment. The segment 1315 can include a second segment. At least a portion of the segment 1315 can be disposed within the segment 1310. For example, the segment 1310 can include a hollow portion that receives at least a portion of the segment 1315. As another example, the segment 1315 can telescope relative to the segment 1310. The segment 1315 can move relative to the segment 1310. For example, the segment 1315 can move from a position within the segment 1310 to a position external to the segment 1310. The segment 1315 can move to adjust a length of the arm 420. For example, the arm 420 can be extended or lengthened with the segment 1315 extended from the segment 1310.

The apparatus 400 can include an interface 1305. The interface 1305 can include a button or a press. The button assembly 1205 can include the interface 1305. The interface 1305 can be disposed on a body of the arm 420. The interface 1305 can release the segment 1315. For example, the interface 1305 can compress the spring 1215 to cause the pin 1210 to disengage with a given groove 1220. To continue this example, the segment 1315 can be released responsive to the disengagement of the pin 1210 from the given groove 1220. The segment 1315 can move, relative to the segment 1310, with the pin 1210 disengaged from the grooves 1220.

The pin 1210 can engage with the grooves 1220. For example, the pin 1210 can engage with a first groove 1220 and a second groove 1220. The pin 1210 can engage with the second groove 1220 responsive to disengagement from the first groove 1220. For example, the interface 1305 can release the pin 1210 causing the pin 1210 to disengage from the first groove 1220. To continue this example, the pin 1210 can subsequently engage with the second groove 1220.

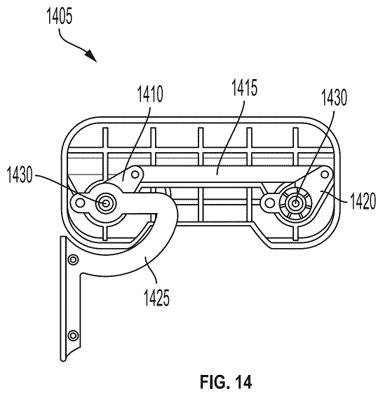

FIG. 14 is a cross-sectional view of a coupling assembly 1405. The apparatus 400 can include the coupling assembly 1405. The coupling assembly 1405 can couple the apparatus 400 with the vehicle 105. For example, the coupling assembly 1405 can couple the apparatus 400 with a crossbar of the vehicle 105. The coupling assembly 1405 can include at least one linkage. For example, in FIG. 14, the coupling assembly 1405 is shown to include linkage 1410, linkage 1415, and linkage 1420. The linkage 1415 can couple the linkage 1410 with the linkage 1420. The linkage 1410 can receive a first fastener 1430. For example, the first fastener 1430 can be inserted into an aperture of the linkage 1410. The linkage 1420 can receive a second fastener 1430. For example, the second fastener 1430 can be inserted into an opening of the linkage 1420.

The coupling assembly 1405 can include at least one lever 1425. The lever 1425 can be coupled with the linkage 1410. For example, the lever 1425 can be secured to the linkage 1410. The lever 1425 can include at least one position. For example, the lever 1425 can include a first position and a second position. The first position or the second position can include an open position. FIG. 14 depicts an example of the lever 1425 in the open position. The lever 1425 can move the linkage 1410 to adjust a position of the fasteners 1430. For example, the lever 1425 can move the linkage 1410 to cause subsequent movement of the linkage 1415 and the linkage 1420. The lever 1425 can move the linkage 1410 to adjust a position of the fasteners 1430. For example, the lever 1425 can move the linkage 1410 to adjust the fasteners 1430 from a first position to a second position.

The linkage 1410 and the linkage 1420 can move from one or more position. For example, the linkage 1410 and the linkage 1420 can move from a first position to a second position. The linkage 1410 and the linkage 1420 can move from the first position to the second position prior to an adjustment in a position of the fasteners 1430. For example, the position of the fasteners 1430 can be maintained as the linkage 1410 and the linkage 1420 begin to move.

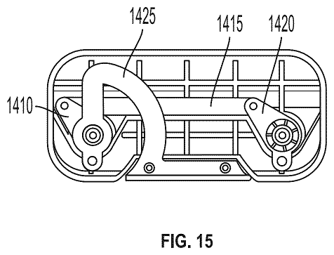

FIG. 15 is cross-sectional view of the coupling assembly 1405. FIG. 15 depicts an example of the lever 1425 in the closed position and an example of the lever 1425 having moved the linkage 1410, the linkage 1415, and the linkage 1420. The apparatus 400 can be coupled with an object with the lever 1425 in the closed position. For example, the apparatus 400 can be coupled with a crossbar of the vehicle 105 with the lever 1425 in the closed position.

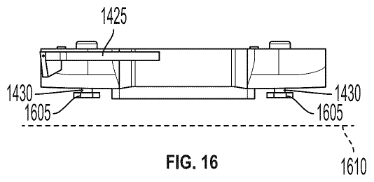

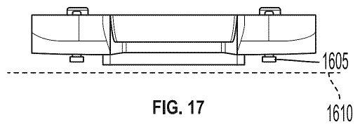

FIGS. 16-17 are perspective views of the coupling assembly 1405. The fasteners 1430 can include at least one portion 1605 or segment 1605. The segments 1605 can be parallel or perpendicular to an axis 1610. The segments 1605 can be parallel, as shown in FIG. 16, with the axis 1610 with the lever 1425 in the open position. The segments 1605 can be perpendicular, as shown in FIG. 17, with the lever 1425 in the closed position. The segments 1605 can move responsive to movement of the linkage 1410 and the linkage 1420. For example, the segments 1605 can move, from the position shown in FIG. 16 to the position shown in FIG. 17, responsive to movement of the linkage 1410 and the linkage 1420, via the lever 1425.

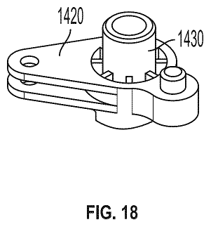

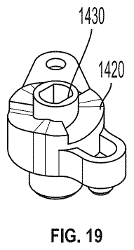

FIGS. 18-19 are perspective views of the linkage 1420. The fastener 1430, as shown in FIG. 18, is inserted into the linkage 1420. The fastener 1430 can refer to or include one or more T-studs. The linkage 1420 can include one or more raised or elevated segments. The raised segments can define movement of the linkage 1420.

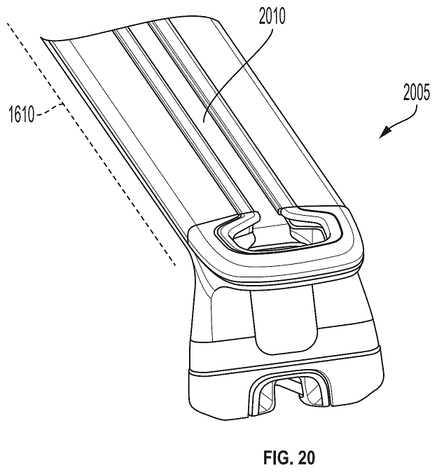

FIG. 20 is a perspective view of a crossbar 2005. The vehicle 105 can include the crossbar 2005. For example, the crossbar 2005 can be located on a roof of the vehicle 105. The crossbar 2005 can include at least one opening 2010. The fasteners 1430 can be inserted within the opening 2010. For example, the fasteners 1430 can be located within the opening 2010. As shown in FIG. 20, the opening 2010 aligns with or is parallel with the axis 1610. The fasteners 1430 can be inserted into the opening 2010 with the fasteners 1430 positioned in the position shown in FIG. 16. The fasteners 1430 can couple with the crossbar 2005. For example, the fasteners 1430 can couple with the crossbar 2005 with the fasteners 1430 positioned in the position shown in FIG. 17.

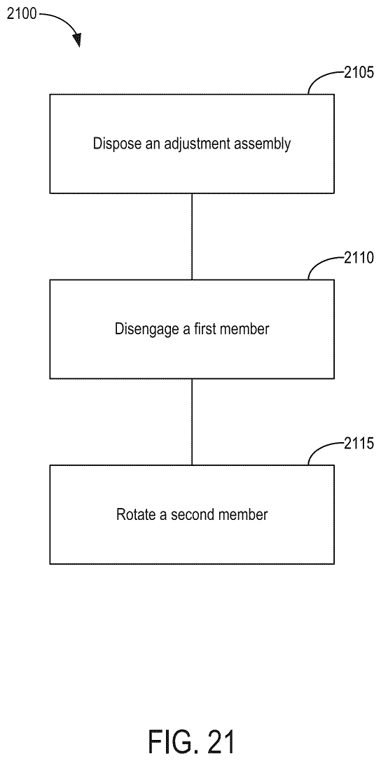

FIG. 21 depicts a block diagram of a process 2100 for manufacturing an apparatus. The apparatus can include the apparatus 400. The apparatus 400 can include the adjustment assembly 505. The manufacturing of the apparatus 400 can include providing the apparatus 400. For example, the apparatus 400 can be provided during assembly of the vehicle 105. The apparatus 400 can also be provided responsive to the apparatus 400 having been purchased.

At act 2105, an adjustment assembly can be disposed. For example, the adjustment assembly 505 can be disposed within the body 405. The adjustment assembly 505 can be disposed within the body 405 by at least one of placing, positioning, locating, or situating the adjustment assembly 505 in the body 405. The adjustment assembly 505 can include the member 510 and the member 515.

At act 2110, a first member can be disengaged. For example, the member 510 can be disengaged from the member 515. The member 510 can be disengaged, from the member 515, responsive to the plane 705 having been inserted into the member 510. The member 510 can compress the spring 530 to disengage from the member 515. The member 515 can be released with the member 510 disengaged from the member 515. For example, the protrusions 715 can release the slots 720.

At act 2115, a second member can rotate. For example, the member 515 can rotate relative to the member 510 with the member 510 disengaged from the member 515. The member 515 can rotate about the axis 525. The spring assembly 540 can apply a torsional force to rotate the member 515. The member 515 can rotate from a first position to a second position to move the arm 420. The member 515 can rotate with the protrusions 715 disengaged from the slots 720.

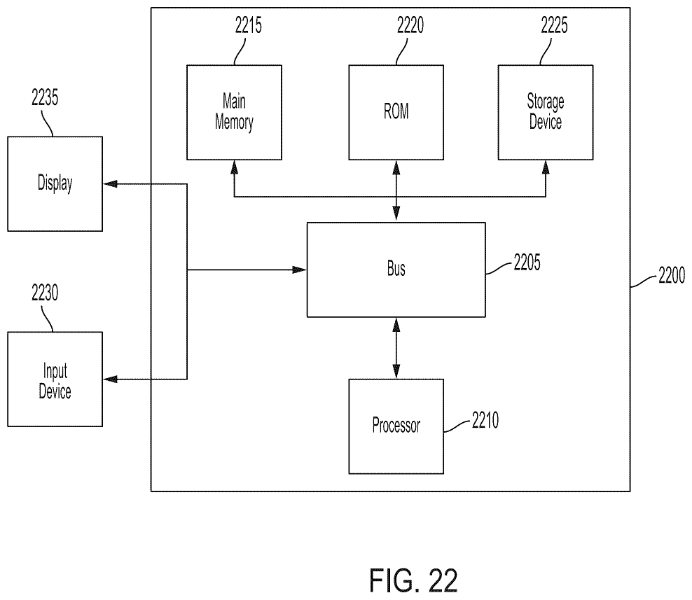

FIG. 22 depicts an example block diagram of an example computer system 2200. The computer system or computing device 2200 can include or be used to implement a data processing system or its components. The computing system 2200 includes at least one bus 2205 or other communication component for communicating information and at least one processor 2210 or processing circuit coupled to the bus 2205 for processing information. The computing system 2200 can also include one or more processors 2210 or processing circuits coupled to the bus for processing information. The computing system 2200 also includes at least one main memory 2215, such as a random access memory (RAM) or other dynamic storage device, coupled to the bus 2205 for storing information, and instructions to be executed by the processor 2210. The main memory 2215 can be used for storing information during execution of instructions by the processor 2210. The computing system 2200 may further include at least one read only memory (ROM) 2220 or other static storage device coupled to the bus 2205 for storing static information and instructions for the processor 2210. A storage device 2225, such as a solid state device, magnetic disk or optical disk, can be coupled to the bus 2205 to persistently store information and instructions.

The computing system 2200 may be coupled via the bus 2205 to a display 2235, such as a liquid crystal display, or active matrix display, for displaying information to a user such as a driver of the electric vehicle 105 or other end user. An input device 2230, such as a keyboard or voice interface may be coupled to the bus 2205 for communicating information and commands to the processor 2210. The input device 2230 can include a touch screen display 2235. The input device 2230 can also include a cursor control, such as a mouse, a trackball, or cursor direction keys, for communicating direction information and command selections to the processor 2210 and for controlling cursor movement on the display 2235.

The processes, systems and methods described herein can be implemented by the computing system 2200 in response to the processor 2210 executing an arrangement of instructions contained in main memory 2215. Such instructions can be read into main memory 2215 from another computer-readable medium, such as the storage device 2225. Execution of the arrangement of instructions contained in main memory 2215 causes the computing system 2200 to perform the illustrative processes described herein. One or more processors in a multi-processing arrangement may also be employed to execute the instructions contained in main memory 2215. Hard-wired circuitry can be used in place of or in combination with software instructions together with the systems and methods described herein. Systems and methods described herein are not limited to any specific combination of hardware circuitry and software.

Although an example computing system has been described in FIG. 22, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
an adjustment assembly configured to move an arm of the apparatus; and
the adjustment assembly including:
a first member and a second member, the first member configured to disengage from the second member; and
the second member configured to rotate relative to the first member to move the arm with the first member disengaged from the second member.

2. The apparatus of claim 1, comprising:
the adjustment assembly configured to dispose within a body of the apparatus; and
the body including an interface assembly configured to interface with the first member to cause the first member to disengage from the second member.

3. The apparatus of claim 1, comprising:
the second member configured to couple with a clutch assembly;
the clutch assembly configured to couple with the arm of the apparatus; and
the clutch assembly configured to rotate with the second member disengaged from the first member.

4. The apparatus of claim 1, comprising:
the first member including a protrusion configured to:
engage with a first slot of the second member to engage the first member with the second member; and
engage with a second slot of the second member to engage the first member with the second member responsive to disengagement of the first member with the second member.

5. The apparatus of claim 1, comprising:
the second member including a first slot and a second slot;
the first slot separated from the second slot by a first angle; and
the first angle to define a rotation amount that the arm of the apparatus rotates about an axis with the first member disengaged from the second member.

6. The apparatus of claim 1, comprising:
a spring assembly configured to rotate the arm of the apparatus with the first member disengaged from the second member.

7. The apparatus of claim 1, comprising:
an interface assembly disposed at least partially external to a body of the apparatus;
the interface assembly including an inclined plane to move the first member along an axis to release the second member; and
the first member including a gap configured to receive the inclined plane.

8. The apparatus of claim 1, comprising:
a mounting assembly including:
a recess configured to receive a protrusion of an attachment assembly to couple the apparatus with a vehicle; and
a lever to move an engagement element to engage the engagement element with the protrusion.

9. The apparatus of claim 8, comprising:
the engagement element configured to move the protrusion from a first position within the recess to a second position within the recess.

10. The apparatus of claim 8, comprising:
the recess including a first portion and a second portion to guide the protrusion to a first position within the mounting assembly.

11. The apparatus of claim 1, comprising:
the arm of the apparatus including a first segment and a second segment;
at least a portion of the second segment configured to dispose within the first segment; and
the second segment configured to be movable relative to the first segment thereby to adjust a length of the arm of the apparatus.

12. The apparatus of claim 11, comprising:
an interface to dispose on a body of the arm of the apparatus; and
the interface configured to release the second segment to adjust the length of the arm of the apparatus.

13. The apparatus of claim 11, comprising:
the second segment including a first groove and a second groove;
an interface to dispose on a body of the arm of the apparatus; and
the interface including an element to:
engage with the first groove; and
engage with the second groove responsive to disengagement with the first groove.

14. The apparatus of claim 1, comprising:
a coupling assembly to couple the apparatus with a crossbar of a vehicle, the coupling assembly including:
a first linkage to receive a first fastener;
a second linkage to receive a second fastener;
a third linkage to couple the first linkage with the second linkage; and
a lever to couple with the first linkage, the lever configured to move the first linkage to adjust a position of the first fastener and a position of the second fastener.

15. The apparatus of claim 14, comprising:
the first linkage and the second linkage configured to move from a first position to a second position prior to an adjustment in the position of the first fastener and the position of the second fastener.

16. The apparatus of claim 14, comprising:
the first fastener and the second fastener configured to insert within an opening of the crossbar of the vehicle; and
the first fastener and the second fastener configured to couple with the crossbar of the vehicle.

17. A vehicle, comprising:
an apparatus, including:
an adjustment assembly configured to move an arm of the apparatus; and
the adjustment assembly including:
a first member and a second member, the first member configured to disengage from the second member; and
the second member configured to rotate relative to the first member to move the arm with the first member disengaged from the second member.

18. The vehicle of claim 17, comprising:
the adjustment assembly configured to dispose within a body of the apparatus; and
the body including an interface assembly to interface with the first member to cause the first member to disengage from the second member.

19. The vehicle of claim 17, comprising:
the second member including a first slot and a second slot;
the first slot separated from the second slot by a first angle; and
the first angle to define a rotation amount that the arm of the apparatus rotates about an axis with the first member disengaged from the second member.

20. A method, comprising:
disposing, within a body of an apparatus, an adjustment assembly including a first member and a second member, the adjustment assembly configured to move an arm of the apparatus;
disengaging, via an interface assembly of the apparatus, the first member from the second member; and
rotating, responsive to disengaging the first member from the second member, the second member to move the arm of the apparatus.
